(19) United States
(12) Patent Application Publication
(10) Pub. No.: US 2016/0314232 A1
(43) Pub. Date: Oct. 27, 2016

(54) FPGA Trace Memory

(71) Applicant: Synopsys, Inc., Mountain View, CA (US)

(72) Inventor: Ludovic Marc Larzul, Folsom, CA (US)

(21) Appl. No.: 15/056,738

(22) Filed: Feb. 29, 2016

Related U.S. Application Data
(60) Provisional application No. 62/151,250, filed on Apr. 22, 2015.

(51) Int. Cl. G06F 17/50

(52) U.S. Cl. CPC G06F 17/5054

(57) ABSTRACT

FPGAs of the emulator include core logic that is configured to emulate circuitry of a DUT. Additionally, emulator FPGAs include a trace memory that stores values of traced signals. As the core logic of an FPGA emulates circuitry of a DUT, certain signals of the DUT are traced. The values of the traced DUT signals are transmitted from the core logic to the trace memory within the FPGA for storage. The traced signal values are transmitted from the core logic to the trace memory through one or more scan chains that are built into the silicon of the FPGA. In one embodiment, traced signal values transmitted to the trace memory pass through a compression unit built into the FPGA. The compression unit performs a compression algorithm on the traced signal values.

### CROSS REFERENCE TO RELATED APPLICATION

This application claims the benefit of U.S. Provisional Application No. 62/151,250, filed Apr. 22, 2015, which is incorporated by reference herein in its entirety.

### BACKGROUND

1. Field of Art

The disclosure generally relates to the emulation of circuits, and more specifically to trace memories and field programmable gate arrays (FPGAs) that emulate circuits.

2. Description of the Related Art

Emulators have been developed to assist circuit designers in designing and debugging highly complex integrated circuits (e.g. CPUs and GPUs). An emulator typically includes multiple boards and each board includes multiple field programmable gate arrays (FPGAs). The emulator's FPGAs can be configured to imitate the operations of a design under test (DUT). By using an emulator to imitate the operations of a DUT, designers can verify that the DUT complies with various design requirements prior to fabrication.

In order to obtain information as to how a DUT is operating, various signals of the DUT are traced during the emulation of the DUT. The values of the traced signals are stored in large memories (e.g., DDR SDRAM) included on the emulator's boards. The traced signal values stored in trace memories are transferred to a computer system for purposes of evaluating the DUT.

Including trace memories on a board forces either an increase in the size of the board (which has higher cost and manufacturing challenges) or maintaining the same size board but reducing other components, typically the number of FPGAs (which impacts performance). Further, an FPGA exchanges data with a trace memory through its interfaces/pads and an FPGA only has a limited number of interfaces. Therefore, the trace memory consumes FPGA resources that could be used to communicate with other FPGAs for purposes of emulating a DUT, directly impacting the performance of the emulator, which is a key advantage of emulation over other technologies and differentiator between emulators.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram of an emulation environment, according to one embodiment.

FIG. 2 is a block diagram illustrating a field programmable gate array (FPGA), according to one embodiment.

FIG. 3 is a circuit diagram of a scan chain, according to one embodiment.

FIG. 4 is a block diagram illustrating a field programmable gate array (FPGA), according to another embodiment.

FIG. 5 illustrates one embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The figures use like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral.

### Configuration Overview

One embodiment of an emulation environment includes a host system and an emulator. The host system transmits information to the emulator to configure the emulator to emulate a design under test (DUT). The emulator includes multiple boards and each board includes multiple field programmable gate arrays (FPGAs). The FPGAs of the emulator include core logic that is configured to emulate circuitry of the DUT based on the information received from the host system. Additionally, FPGAs of the emulator include a trace memory that stores values of traced signals. In one embodiment, the trace memory is composed of multiple memories that are organized logically into a larger memory in charge of tracing signal values from the design. The trace memory is located on the side of the FPGA core logic die like as a separate die or a stacked die, or within the same multi-chip package. Hence, the trace memory and FPGA logic are on different dies but part of the same FPGA package. The trace memory die and the core logic die are connected via one or more inter-die connections.

As the core logic of an FPGA emulates circuitry of a DUT, certain signals of the DUT are traced. The values of the traced DUT signals are transmitted from the core logic to the trace memory within the FPGA for storage. In one embodiment, the traced signal values are transmitted from the core logic to the trace memory through one or more scan chains that are built into the silicon of the FPGA. The scan chains and inter-die connections connect the core logic to the trace memory. By using scan chains that are built into the FPGA, the FPGA's core logic does not need to be used for transmitting the traced signal values to the trace memory. In another embodiment, the traced signal values are selected through a set of multiplexors, which may or may not be coupled with a scan chain. In another embodiment, traced signal values transmitted to the trace memory pass through a compression unit built into the FPGA. The compression unit performs a compression algorithm on the traced signal values. The compression algorithm minimizes the amount of data stored in the trace memory. In another embodiment, a first level of small memories are embedded in the FPGA's core logic as buffers, whose outputs are connected to the main trace memory.

By including trace memories within FPGAs it saves space on the emulator boards and allows each emulator board to include more FPGAs that can be used to emulate a DUT, resulting in potential lower foot-print of the emulation system. Additionally, since an FPGA's external interfaces do not need to be used to communicate with an external trace memory, more interfaces of the FPGA can be used to communicate with other FPGAs during emulation of a DUT. Further, including trace memories within FPGAs increases the memory bandwidth between the core logic and the trace memory. Typically, the bandwidth between an external trace memory and an FPGA is limited by the FPGA's interfaces. However, since the interfaces are not used to exchange data between the core logic and the trace memory within the FPGA, the memory bandwidth increases. Also, since the distance between the trace memory and the logic within the FPGA package is shorter than the distance with an external memory, the frequency used to trace, multiplex, shift and/or process the traced signal values can be higher than through an external interface, potentially also improving the latency.

### Example Emulation Environment

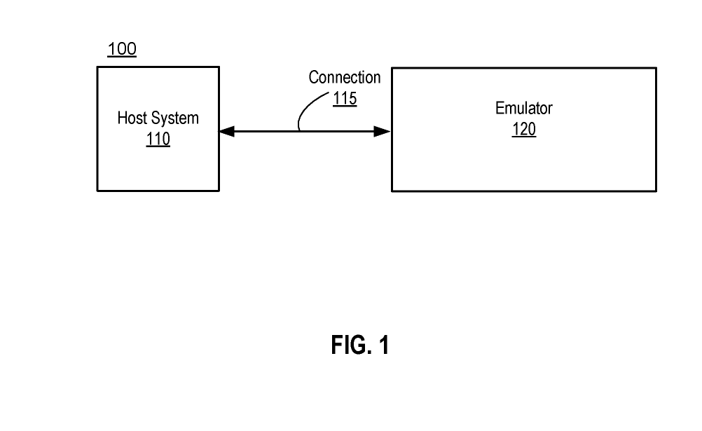

FIG. 1 is a block diagram illustrating an emulation environment 100, according to one embodiment. The emulation environment 100 includes a host system 110 and an emulator 120. The host system 110 communicates with the emulator 120 through a connection 115.

The connection 115 is a communication medium that allows communication between the host system 110 and the emulator 120. In one embodiment, the connection 115 is one or more cables with electrical connections. For example, the connection 115 may be one or more RS232, USB, LAN, optical, or custom built cables. In other embodiment, the connection 115 is a wireless communication medium or a network with one or more points of access. For another example, the connection 115 may be a wireless communication medium employing a Bluetooth® or IEEE 802.11 protocol.

The host system 110 may be a single computer or a collection of multiple computers. In the embodiment where the host system 110 is comprised of multiple computers, the functions described herein as being performed by the host system 110 may be distributed among the multiple computers. Further, the host system 110 may be indirectly connected to the emulator 120 through another device, computer or network.

The host system 110 receives (e.g., from a user) a description of a DUT that is to be emulated. In one embodiment, the DUT description is in a hardware description language (HDL), such as register transfer language (RTL). In another embodiment, the DUT description is in netlist level files, or a mix of netlist level files and HDL files. If part of the DUT description or the entire DUT description is in a HDL, the host system 110 synthesizes the DUT description to create a gate level netlist based on the DUT description. The host system 110 uses the netlist of the DUT to partition the DUT into multiple partitions. The host system 110 maps each partition to the core logic of an FPGA included in the emulator 120.

In one embodiment, the host system 110 includes trace logic with the DUT. For example, the host system 110 can include the trace logic during the synthesizing of the DUT or after the partitioning of the DUT. The trace logic traces specific signals of the DUT during emulation of the DUT. DUT signal values traced by the trace logic during emulation of the DUT are stored in trace memories included in the FPGAs as described in more detail below. In another embodiment, the description of the DUT is received by the host system 110 with the trace logic already included. In another embodiment, the trace logic is embedded in the silicon of each FPGA and connected physically to the trace memory in the FPGA.

The host system 110 creates bit files to configure the emulator 120 to emulate the DUT. In one embodiment, the created bit files describe each partition of the DUT and the mapping of the partitions to the emulator FPGAs. The bit files may also include information describing connections between components and the routing of the connections. The host system 110 transmits the bit files to emulator 120 at the request of a user to configure the emulator 120.

While the emulator 120 emulates the DUT or at the end of the DUT emulation, the host system 110 receives emulation results from the emulator 120 through the connection 115. The host system 110 stores the emulation results. Emulation results are information generated by the emulator 120 based on the emulation of the DUT. The emulation results include values of DUT signals traced during the emulation of the DUT. The traced signal values are retrieved from trace memories included in the emulator FPGAs.

The emulator 120 is a hardware system that emulates DUTs. The emulator 120 includes multiple boards (e.g., printed circuit boards) and each board includes multiple FPGAs. Although, the emulator 120 is described here as including FPGAs, it should be understood that in other embodiments the emulator 120 may include, exclusively or not, other types of reconfigurable logic blocks instead of the FPGAs for emulating DUTs.

For a DUT that is to be emulated, the emulator 120 receives from the host system 110 bit files describing partitions of the DUT created by the host system 110 and the mappings of the partitions to the FPGAs of the emulator 120. Based on the bit files, the emulator 120 configures the FPGAs to perform the functions of the DUT.

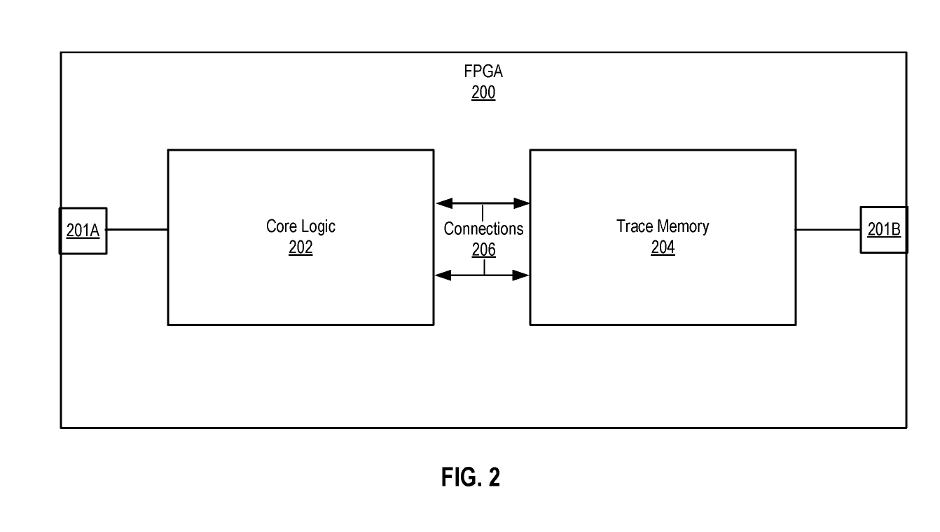

As illustrated by FIG. 2, an FPGA 200 included in the emulator 120 includes multiple interfaces 201A and 201B, core logic 202, and a trace memory 204. The FPGA 200 is connected with other components (e.g., other FPGAs) through the interfaces 201. Hence, through the interfaces 201 components of the FPGA 200 can exchange information with components outside of the FPGA 200. In this example, interface 201A is illustrated as being connected to the core logic 202 and interface 201B is illustrated as being connected to the trace memory 204. The interfaces 201 could be a single interface shared by the core logic 202 and the trace memory 204.

The core logic 202 includes components that can be configured to emulate the circuitry of a DUT. In one embodiment, the components of the core logic 202 include logic blocks. A logic block, for example, may consist of lookup tables, adders, and flip-flops. Based on the bit files received from the host system 110, the components of the core logic 202 are configured to emulate a partition of the DUT mapped to the FPGA 200 by the host system 110. In one embodiment, the partition includes trace logic that traces certain signals of the DUT during emulation. In another embodiment, the bit files include the configuration of the connections 206 and/or interfaces 201.

When the core logic 202 emulates its respective partition of the DUT, values of DUT signals traced by the core logic 202 are stored in the trace memory 204 via connections 206. Hence, the trace memory 204 is a memory that stores DUT signal values traced by the core logic 202 and is included in the same FPGA 200 (same package) as the trace memory 204. The trace memory 204 may be, for example, a DDR SDRAM or a LPDDR. In one embodiment, the trace memory 204 is a large memory with the capacity to store signal values for a large number of signals and for a large number of DUT cycles. For example, the trace memory 204 may have a size of multiple gigabytes of data, allowing for the storage of a few million bits per cycle during a few million cycles. The number of signals traced and number of cycles can vary proportionally so the entire trace memory 204 is used if required.

The core logic 202 is included on a separate die than the trace memory 204, but both dies are part of the same FPGA package. In one embodiment, the core logic die and the trace memory die are side by side on the same package substrate (e.g., 2D). In another embodiment, the FPGA 200 includes a stack of dies and the stack includes the core logic die and/or the trace memory die (e.g., 2.5D or 3D).

During emulation of the DUT or at the end of the emulation, the traced signal values stored in the trace memory 204 are read from the trace memory 204 and transmitted to host system 110, for example, via interface 201B (e.g., output port). In one embodiment, the host system 110 requests the specific traced signal values that are to be provided to the host system 110. In another embodiment, all of the traced signal values stored in the memory 204 are transmitted to the host system 110 (e.g., periodically in batches). In one embodiment, interface 201A is included in the core logic die and interface 201B is included in the trace memory die.

As described above, values of the DUT signals traced by the core logic 202 are transferred from the core logic 202 to the trace memory 204 for storage via connections 206. At least part of each connection 206 is built into the silicon of the FPGA 200 during fabrication of the FPGA 200. Because the connections 206 are built into the FPGA's silicon, logic from the core logic 202 does not need to be used to store traced signal values in the trace memory 204. This frees up logic for the emulation of the DUT circuitry.

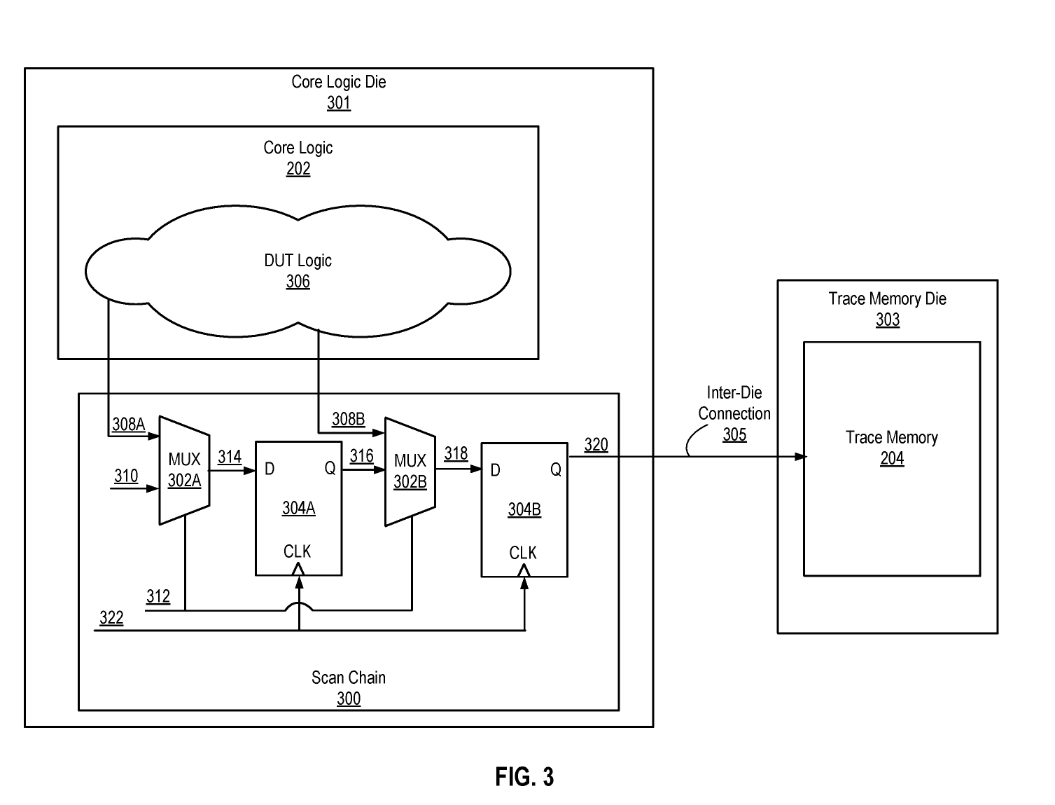

In one embodiment, a connection 206 between the core logic 202 and the trace memory 204 includes a scan chain and/or an inter-die connection. FIG. 3 illustrates a core logic die 301 including the core logic 202 and a trace memory die 303 including the trace memory 204. FIG. 3 further illustrates the core logic die 301 including a scan chain 300 and an inter-die connection 305 connecting the core logic die 301 and the trace memory die 303. The scan chain 300 and the inter-die connection 305 transfer signal values of the DUT traced by the core logic 202 to the trace memory 204 for storage. The scan chain 300 includes two multiplexers (MUXs) 302A and 302B and two flip flops 304A and 304B.

The core logic 202 emulates logic 306 of the DUT (DUT logic 306). MUX 302A receives a DUT signal value 308A traced by the core logic 202 as a first input and a scan-in signal 310 as a second input. The MUX 302A also receives a selection signal 312. The output of MUX 302A is received by flip flop 304A as an input. The flip flop 304A also receives a scan chain clock signal 322. MUX 302B receives another DUT signal value 308B traced by the core logic 202 as a first input and the output 316 of flip flop 304A as a second input. MUX 302B also receives the selection signal 312. Flip flop 304B receives the output of MUX 302B as an input and also receives scan chain clock signal 322. The output 320 of flip flop 304B is stored in the trace memory 204 via inter-die connection 305. The inter-die connection may be, for example, a wire or a through-silicon via (TSV) connection. In another embodiment, each signal 308 is not connected directly to a MUX 302, but rather it is first sampled by a sampling register whose input is connected to the signal 308 and the output is connected to the MUX 302.

When traced DUT signal values are to be stored in the trace memory 204, selection signal 312 is set to a first state in order to read the values into the scan chain 300. Based on the first state of the selection signal 312, MUX 302A selects and outputs traced signal value 308A. Additionally, based on the first state of the selection signal 312, MUX 302B selects and outputs traced signal value 308B. Flip flop 304A stores signal value 308A and flip flop 304B stores signal value 308B.

During subsequent clock cycles of the scan chain clock signal 322, the traced signal values 308 are transferred from the flip flops 304 to the trace memory 204. In order to do this the selection signal 312 is set to a second state. During a first subsequent clock cycle of signal 322, flip flop 304B outputs signal value 308B and the value 308B is stored in the trace memory 204 via inter-die connection 305. Flip flop 304A outputs signal value 308A and based on the second state of the selection signal 312, MUX 302B selects and outputs signal value 308A. Flip flop 304B stores the signal value 308A. During a second subsequent clock cycle of signal 322, flip flop 304B outputs signal value 308A and the value 308A is stored in the trace memory 204 via inter-die connection 305.

The scan chain clock signal 322 is operating at a higher frequency than the clock of the DUT. The higher frequency allows the scan chain 300 to be able to read traced signal values and transfer the values through the chain 300 and the inter-die connection 305 to the trace memory 204 during a single clock cycle of the DUT. In one embodiment, the transfer of the traced signal values can happen in parallel of the DUT execution on the DUT logic 306, once the traced signal values are captured on the registers 304.

FIG. 3 illustrates the scan chain 300 as only being included on the core logic die 301. However, in other embodiments part of the scan chain 300 may be included in the core logic die 301 and another part of the scan chain 300 may be included in the trace memory die 303. The part of the scan chain 300 on the core logic die 301 connects the core logic 202 to the inter-die connection 305 and the part of the scan chain 300 on the trace memory die 303 connects the trace memory 204 to the inter-die connection 305.

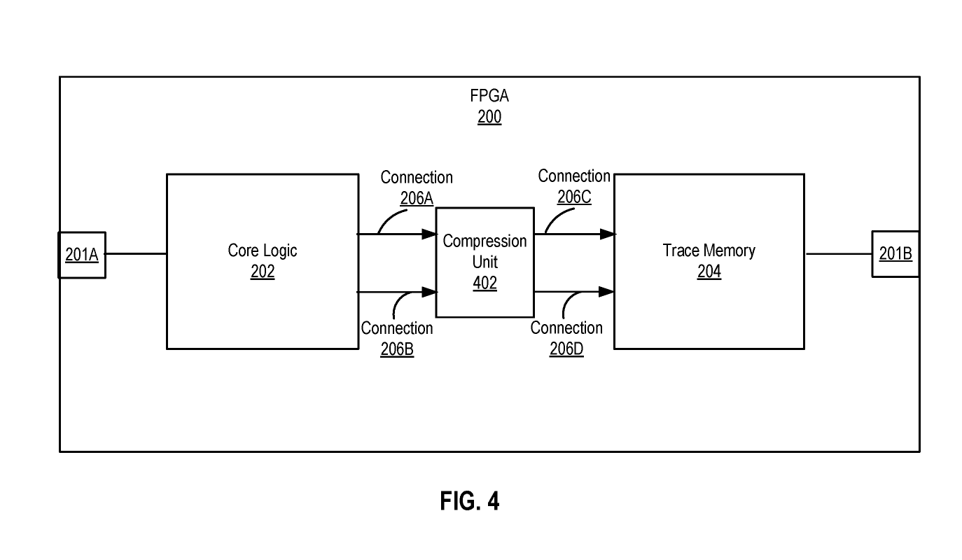

In another embodiment, instead of the traced signal values being transferred directly from the core logic 202 to the trace memory 204, traced signal values are transferred from the core logic 202 to a compression unit. The compression unit may be included in the core logic die 301 or the trace memory die 303. FIG. 4 illustrates an example configuration of the FPGA 200 according to this embodiment. The core logic 202 is connected to compression unit 402 via connections 206A and 206B and the compression unit 402 is connected to the trace memory 204 via connections 206C and 206D.

The compression unit 402 is built into the silicon of the FPGA 200 during fabrication of the FPGA 200. The compression unit 402 is configured to perform a compression algorithm on traced signal values received from the core logic 202 in order to reduce the amount of data that is stored in the trace memory 204. For example, if the compression unit 402 receives the value of a traced signal from the core logic 202 and the value is the same as the value of the signal from the preceding DUT clock signal (i.e., the signal has not changed), the compression unit 402 determines not store the received traced signal value in the trace memory 204. However, if the received signal value is different, the compression unit 402 stores the traced signal value in the trace memory 204 via connection 206C or 206D. In another embodiment, some logic from the core logic 202 is used to perform the compression. In one embodiment, the compression unit 402 performs GZIP or LZ77, or similar, compression algorithms on traced signal values. In one embodiment, the compression unit 402 does at least a transformation of values into events, reading previous traced signal values from the trace memory 204 or from a temporary memory.

### Computing Machine Architecture

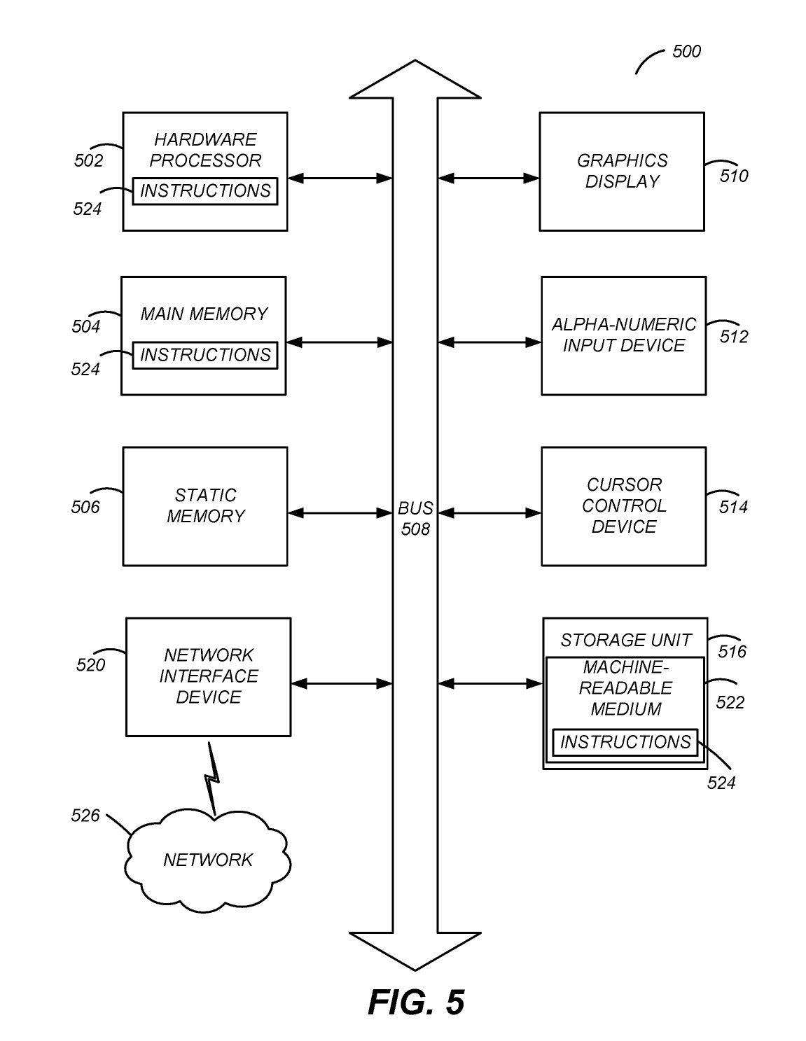

Turning now to FIG. 5, it is a block diagram illustrating components of an example machine able to read instructions from a machine-readable medium and execute them in a processor (or controller). Specifically, FIG. 5 shows a diagrammatic representation of a machine in the example form of a computer system 500 within which instructions 524 (e.g., software or program code) for causing the machine to perform (execute) any one or more of the methodologies described with FIGS. 1-4. The computer system 500 may be used for one or more of the entities (e.g., host system 110) illustrated in the emulation environment 100 of FIG. 1.

The example computer system 500 includes a hardware processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a storage unit 516, a signal generation device 618 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

As is known in the art, a computer system 500 can have different and/or other components than those shown in FIG. 5. In addition, the computer system 500 can lack certain illustrated components. For example, a computer system 500 acting as the host system 110 may include a hardware processor 502, a storage unit 516, and a network interface device 520, but may lack a cursor control device 514.

### Additional Configuration Considerations

It is noted that although the subject matter is described in the context of emulation environment for emulation of digital circuits and systems, the principles described may be applied to any electronic devices. While the examples herein are in the context of an emulation environment, the principles described herein can apply to other analysis of hardware implementations of digital circuitries, including FPGA and ASIC or software simulation such as EDAs.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-5. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software (or computer program code)) may be driven by cost and time considerations.

The various operations of example methods described herein may be performed, at least partially, by one or more processors, e.g., processor 902, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for efficient power analysis of a digital circuit through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A field programmable gate array (FPGA) comprising:
a first die comprising:
core logic including reconfigurable components;
a scan chain connecting the core logic to an inter-die connection;
the inter-die connection connecting the first die and a second die; and
the second die comprising:
a trace memory configured to store information received from the core logic via the inter-die connection; and
an output port configured to output the stored information to a system not included in the FPGA.

2. The FPGA of claim 1, wherein the first die and the second die share the same package substrate.

3. The FPGA of claim 1, wherein the inter-die connection is a through-silicon via (TSV) connection.

4. The FPGA of claim 1, wherein the FPGA comprises a stack of dies including at least one of the first die and the second die.

5. The FPGA of claim 1, wherein second die further comprises the scan chain connecting the trace memory to the inter-die connection.

6. The FPGA of claim 1, wherein the:
core logic is configured to:
emulate circuitry of a design under test (DUT); and
generate a traced signal value based on the emulation of the circuitry of the DUT; and
the trace memory is configured to store the traced signal value received via the scan chain and the inter-die connection.

7. The FPGA of claim 6, further comprising:
a compression unit compressing the traced signal value and additional traced signal values.

8. The FPGA of claim 7, wherein the compression unit is configured to:
determine whether the traced signal value is different than an additional signal value from a preceding clock cycle of the DUT; and
determine to store the traced signal value in the trace memory in response to the traced signal value being different than the additional signal value.

9. The FPGA of claim 7, wherein the compression unit is configured to:
identify an additional signal value from a subsequent clock cycle generated based on emulation of the circuitry;
determine whether the additional signal value is different than the traced signal value stored by the trace memory; and
determine not to store the additional signal value in the trace memory in response to the additional signal value being the same as the traced signal value.

10. The FPGA of claim 1, wherein the scan chain includes one or more multiplexing elements and one or more sequential elements, at least one of the multiplexing elements or sequential elements having a connection with the core logic

11. The FPGA of claim 1, wherein the FPGA is included in an emulator comprising a plurality of FPGAs configured to emulate a DUT.

12. A method comprising:
generating, by core logic, information based on the emulation of a circuit, the core logic included in a first die of a field programmable gate array (FPGA) and the core logic including reconfigurable components;
storing, by a trace memory, the information received from the core logic via a scan chain and an inter-die connection, the trace memory included in a second die of the FPGA; and
outputting the stored information to a system not included in the FPGA.

13. The method of claim 12, wherein the scan chain connects the core logic to the inter-die connection and the inter-die connection connects the first die and the second die.

14. The method of claim 12, wherein the first die and the second die share the same FPGA package substrate.

15. The method of claim 12, wherein the FPGA comprises a stack of dies including at least one of the first die and the second die.

16. The method of claim 12, wherein the information is a traced signal value generated by the core logic based on the emulation of circuitry of a design under test (DUT).

17. The method of claim 16, further comprising
determining whether the traced signal value is different than an additional signal value from a preceding clock cycle of the DUT; and
determining to store the traced signal value in the trace memory in response to the traced signal value being different than the additional signal value.

18. The method of claim 16, further comprising
identifying an additional signal value from a subsequent clock cycle generated based on emulation of the circuitry;
determining whether the additional signal value is different than the traced signal value stored by the trace memory; and
determining not to store the additional signal value in the trace memory in response to the additional signal value being the same as the traced signal value.

19. The method of claim 12, wherein the second die comprises the scan chain, the scan chain connecting the trace memory to the inter-die connection.

20. The method of claim 12, wherein the scan chain includes one or more multiplexing elements and one or more sequential elements, at least one of the multiplexing elements or sequential elements having a connection with the core logic
